(19) United States
(12) Patent Application Publication
(10) Pub. No.: US 2021/0371637 A1
(43) Pub. Date: Dec. 2, 2021

(54) POLY(VINYL CHLORIDE) MIXTURES FOR WIRE AND CABLE COVERINGS

(71) Applicant: Geon Performance Solutions, LLC, Westlake, OH (US)

(72) Inventors: Craig L. Shoemaker, North Ridgeville, OH (US); Amjad Abu-Ali, Avon Lake, OH (US); John L. Grant, Amherst, OH (US)

(73) Assignee: Geon Performance Solutions, LLC, Westlake, OH (US)

(21) Appl. No.: 17/287,973

(22) PCT Filed: Oct. 21, 2019
(86) PCT No.: PCT/US2019/057202

§ 371 Date: Apr. 22, 2021

Related U.S. Application Data
(60) Provisional application No. 62/750,787, filed on Oct. 25, 2018.

(51) Int. Cl. C08L 27/06; C08K 5/00; C08K 5/10; C08L 67/04; C08K 5/092; C08K 3/016; C08K 9/06; C08L 23/06; C08K 3/014; H01B 3/44; C08K 3/22

(52) U.S. Cl. CPC C08L 27/06; C08K 2003/2217; C08K 5/10; C08L 67/04; C08K 5/092; C08K 3/016; C08K 9/06; C08L 23/06; C08K 3/014; H01B 3/443; C08K 3/2279; C08L 2201/02; C08L 2203/202; C08K 2003/2227; C08K 5/0016

(57) ABSTRACT

A flame retardant, flexible polyvinyl chloride mixture includes a trio of plasticizers and molybdate-based smoke suppressant for use in wire and cable articles.

### CLAIM OF PRIORITY

This application claims the benefit of U.S. Provisional Patent Application Ser. No. 62/750,787 bearing Attorney Docket Number 12018032 and filed on Oct. 25, 2018, which is hereby incorporated by reference in its entirety.

### FIELD OF THE INVENTION

This invention concerns use of poly(vinyl chloride) mixtures as a possible replacement for polyvinylidene fluoride in wire and cable coverings, such as insulation and jacketing.

### BACKGROUND OF THE INVENTION

People benefit from plastic articles. From their invention in the mid-20th Century until the present, thermoplastic polymers have become the composition of many consumer products. Such products are relatively lightweight, sturdy, and corrosion resistant.

Plasticized poly(vinyl chloride), invented by Waldo Semon of B.F. Goodrich, has been a top performing plastic resin for decades. Billions of kilograms of poly(vinyl chloride) (also known as “PVC”) resin are molded and extruded each year into countless products. With conventional additives, poly(vinyl chloride) provides unparalleled durability, flame resistance, chemical resistance, weatherability, electrical properties and clarity to name a few.

Wire and cable manufacturers often use plasticized PVC for insulation and sheathing. Performance of plasticized PVC compound at various temperatures is predicted based on accelerated oven aging tests. A cable rated at 60° C. by Underwriters' Laboratories (UL) is tested at 100° C. for seven days, whereas a cable rated at 75° C. is tested at 100° C. for ten days. Some plasticizers conventionally used are phthalates, citrates, soyates, and trimellitates.

Some wire and cable requirements include low smoke generation, measured using both peak optical density and average optical density. PVC plasticized with low smoke plasticizers like phosphates, are particularly suitable in that circumstance. But these formulations are inadequate because they do not pass the UL-910 burn test in certain plenum cable constructions.

When a compound of PVC plasticized with low smoke plasticizers is unable to pass the UL-910 burn test, wire and cable manufacturers use polyvinylidene fluoride (PVDF) for coverings such as insulation and jacketing, particularly jacketing, when the wire or cable is to be used in a plenum construction application which requires low smoke generation.

PVDF is expensive, has difficulty in compatibility with other thermoplastic resins, and sometimes is scarce as a raw material in the market.

### SUMMARY OF THE INVENTION

What is needed in the art is a plasticized PVC compound to replace PVDF in wire and cable formulations for “coverings”, a term of art which includes both insulation and jacketing materials, particularly for uses in building construction such as riser and plenum locations, whether indoors, outdoors, or both, and more particularly for wire and cable jacketing requiring low smoke generation.

The present invention solves that problem by using molybdate-based smoke suppressants in a PVC compound to achieve both physical properties and indicators of flame retardant properties.

One aspect of the present invention is a mixture comprising (a) poly(vinyl chloride); (b) brominated dioctyl phthalate plasticizing the poly(vinyl chloride); (c) polycaprolactone plasticizing the poly(vinyl chloride); (d) linear C₉ trimellitate plasticizing the poly(vinyl chloride); (e) silane surface treated aluminum trihydrate flame retardant; (f) antimony trioxide flame retardant; (g) intumescent char former; (h) molybdate-based smoke suppressant; (i) stearic acid; (j) oxidized polyethylene wax; and (k) calcium/zinc stabilizer; wherein the mixture has both a Limiting Oxygen Index of greater 50% according to ASTM D2863 and a Plastic Brittleness less than 0° C. according to ASTM D746 as measured in 2° C. increments.

Another aspect of the present invention is a wire or cable covering, comprising the mixture described above.

Another aspect of the present invention is a wire or cable covering described above, wherein the wire or cable is a plenum wire or cable.

Another aspect of the present invention is a wire or cable insulation or jacketing described above, wherein the wire or cable is a riser wire or cable.

It is also desirable for the mixture to have the following physical properties: an unaged Elongation at Break of greater than 100% according to ASTM D638 (Type IV); and a Dynamic Thermal Stability of at least about 30 min. according to ASTM 2538.

Another aspect of the present invention is a method of using plasticized poly(vinyl chloride) in wire or cable covering, comprising the steps: (a) melt mixing ingredients of the mixture described above to form a plasticized polyvinyl chloride; and (b) extruding the plasticized polyvinyl chloride around a transmission core of optical fiber or metal wire to form a plenum wire or cable.

Additional advantages of the invention are explained in reference to embodiments of the invention.

### EMBODIMENTS OF THE INVENTION

Polyvinyl Chloride Resins

Polyvinyl chloride polymers are widely available throughout the world. Polyvinyl chloride resin as referred to in this specification includes polyvinyl chloride homopolymers, vinyl chloride copolymers, graft copolymers, and vinyl chloride polymers polymerized in the presence of any other polymer such as a HDT distortion temperature enhancing polymer, impact toughener, barrier polymer, chain transfer agent, stabilizer, plasticizer or flow modifier.

For example a combination of modifications may be made with the PVC polymer by overpolymerizing a low viscosity, high glass transition temperature (Tg) enhancing agent such as SAN resin, or an imidized polymethacrylate in the presence of a chain transfer agent.

In another alternative, vinyl chloride may be polymerized in the presence of said Tg enhancing agent, the agent having been formed prior to or during the vinyl chloride polymerization. However, only those resins possessing the specified average particle size and degree of friability exhibit the advantages applicable to the practice of the present invention.

In the practice of the invention, there may be used polyvinyl chloride homopolymers or copolymers of polyvinyl chloride comprising one or more comonomers copolymerizable therewith. Suitable comonomers for vinyl chloride include acrylic and methacrylic acids; esters of acrylic and methacrylic acid, wherein the ester portion has from 1 to 12 carbon atoms, for example methyl, ethyl, butyl and ethylhexyl acrylates and the like; methyl, ethyl and butyl methacrylates and the like; hydroxyalkyl esters of acrylic and methacrylic acid, for example hydroxymethyl acrylate, hydroxyethyl acrylate, hydroxyethyl methacrylate and the like; glycidyl esters of acrylic and methacrylic acid, for example glycidyl acrylate, glycidyl methacrylate and the like; alpha, beta unsaturated dicarboxylic acids and their anhydrides, for example maleic acid, fumaric acid, itaconic acid and acid anhydrides of these, and the like; acrylamide and methacrylamide; acrylonitrile and methacrylonitrile; maleimides, for example, N-cyclohexyl maleimide; olefin, for example ethylene, propylene, isobutylene, hexene, and the like; vinylidene chloride, for example, vinylidene chloride; vinyl ester, for example vinyl acetate; vinyl ether, for example methyl vinyl ether, allyl glycidyl ether, n-butyl vinyl ether and the like; crosslinking monomers, for example diallyl phthalate, ethylene glycol dimethacrylate, methylene bis-acrylamide, tracrylyl triazine, divinyl ether, allyl silanes and the like; and including mixtures of any of the above comonomers.

The present invention can also use chlorinated polyvinyl chloride (CPVC), wherein PVC containing approximately 57% chlorine is further reacted with chlorine radicals produced from chlorine gas dispersed in water and irradiated to generate chlorine radicals dissolved in water to produce CPVC, a polymer with a higher glass transition temperature (Tg) and heat distortion temperature. Commercial CPVC typically contains by weight from about 58% to about 70% and preferably from about 63% to about 68% chlorine. CPVC copolymers can be obtained by chlorinating such PVC copolymers using conventional methods such as that described in U.S. Pat. No. 2,996,489, which is incorporated herein by reference. Commercial sources of CPVC include Lubrizol Corporation.

The preferred composition is a polyvinyl chloride homopolymer, such as PVC suspension resin grade 240 commercially available from OxyVinyl LP.

Commercially available sources of polyvinyl chloride polymers include OxyVinyls LP of Dallas, Tex. and Shintech USA of Freeport, Tex.

PVC Mixtures

Flexible PVC resin mixtures typically contain a variety of additives selected according to the performance requirements of the article produced therefrom well within the understanding of one skilled in the art without the necessity of undue experimentation.

The PVC mixtures used herein contain effective amounts of additives measured per 100 weight parts of PVC (parts per hundred resin- phr or PHR).

For example, various primary and/or secondary lubricants such as oxidized polyethylene, paraffin wax, fatty acids, and fatty esters and the like can be utilized.

Thermal and ultra-violet light (UV) stabilizers can be utilized such as various organo tins, for example dibutyl tin, dibutyltin-S-S′-bi-(isooctylmercaptoacetate), dibutyl tin dilaurate, dimethyl tin diisooctylthioglycolate, mixed metal stabilizers like Barium Zinc and Calcium Zinc, and lead stabilizers (tri-basic lead sulfate, di-basic lead phthalate, for example). Secondary stabilizers may be included for example a metal salt of phosphoric acid, polyols, and epoxidized oils. Specific examples of salts include water-soluble, alkali metal phosphate salts, disodium hydrogen phosphate, orthophosphates such as mono-, di-, and tri-orthophosphates of said alkali metals, alkali metal polyphosphates, -tetrapolyphosphates and -metaphosphates and the like. Polyols such as sugar alcohols, and epoxides such as epoxidized soybean oil can be used.

In addition, antioxidants such as phenolics, BPA, BHT, BHA, various hindered phenols and various inhibitors like substituted benzophenones can be utilized.

Various processing aids, fillers, pigments, flame retardants and reinforcing materials can also be utilized in amounts up to about 200 or 300 phr.

Adjustment of melt viscosity can be achieved as well as increasing melt strength by employing commercial acrylic process aids such as those from Rohm and Haas under the Paraloid® trademark. Paraloid®. K-120ND, K-120N, K-175, and other processing aids are disclosed in The Plastics and Rubber Institute: International Conference on PVC Processing, Apr. 26-28 (1983), Paper No. 17.

Examples of fillers include calcium carbonate, clay, silica and various silicates, talc, carbon black and the like. Reinforcing materials include glass fibers, polymer fibers and cellulose fibers. Also, flame retardant fillers like ATH (Aluminum trihydrates), AOM (ammonium octamolybdate), antimony trioxides, magnesium oxides and zinc borates are added to boost the flame retardancy of polyvinyl chloride. Examples of various pigments include titanium dioxide, carbon black and the like. Mixtures of fillers, pigments and/or reinforcing materials also can be used.

The compound of the present invention can include other conventional plastics additives in an amount that is sufficient to obtain a desired processing or performance property for the compound. The amount should not be wasteful of the additive nor detrimental to the processing or performance of the compound. Those skilled in the art of thermoplastics compounding, without undue experimentation but with reference to such treatises as Plastics Additives Database (2004) from Plastics Design Library (www.elsevier.com), can select from many different types of additives for inclusion into the mixtures of the present invention.

Non-limiting examples of other optional additives include adhesion promoters; biocides (antibacterials, fungicides, and mildewcides), anti-fogging agents; anti-static agents; bonding, blowing and foaming agents; dispersants; fillers and extenders; fire and flame retardants and other smoke suppressants; impact modifiers; initiators; lubricants; micas; pigments, colorants and dyes; plasticizers; processing aids; release agents; silanes, titanates and zirconates; slip and anti-blocking agents; stabilizers; stearates; ultraviolet light absorbers; viscosity regulators; waxes; and combinations of them.

Table 1 identifies the types of ingredients and their amounts, preferred for the mixture of the present invention, the amounts expressed in parts-per-hundred of PVC resin (PHR).

TABLE 1

| Ingredient (PHR) | Acceptable | Desirable | Preferred |
|---|---|---|---|
| Poly(vinyl chloride) | 100 | 100 | 100 |
| Phthalate Plasticizer | 23-27 | 24-26 | 25 |
| Polycaprolactone Plasticizer | 10-20 | 12-18 | 15 |
| Linear C₉ | 12-18 | 13-17 | 15 |
| Trimellitate Plasticizer | | | |
| Aluminum Trihydrate Flame Retardant | 75-85 | 78-82 | 80 |
| Antimony Trioxide Flame Retardant | 1-5 | 2-3 | 2 |
| Intumescent Char Former | 3-7 | 4-6 | 5 |
| Molybdate-based Smoke Suppressant | 10-50 | 15-40 | 20-30 |
| Stearic Acid Lubricant | 0.05-1 | 0.04-0.5 | 0.1 |
| Oxidized Polyethylene Wax | 0.1-1 | 0.3-0.7 | 0.5 |
| Calcium/Zinc Stabilizer | 3-9 | 5-8 | 7 |

Processing

The preparation of mixtures of the present invention is as follows. The compound of the present can be made in batch or continuous operations from a powder blend which is typically prepared in a batch-wise operation.

Such powder blending in a batch process typically occurs in a powder mixer such as a Henschel or Littleford mixer, or a ribbon blender that physically mixes all the additives including liquid plasticizers with PVC resin without bringing the polymer matrix to a melting temperature. The mixing speeds range from 60 to 3000 rpm and temperature of mixing can be ambient up to 250° F. (121° C.). In the present invention, all powders are heated to 140° F. (60° C.) and then the polycaprolactone pellets are added, with the mixture then being dropped at 155° F. (68° C.). The output from the mixer is a well blended powder product that can flow into a machine that can bring up the blend temperature to induce melting of some ingredients including the PVC resin.

Mixing in a batch process typically occurs in a Banbury mixer that is also elevated to a temperature that is sufficient to melt the polymer matrix to permit addition of the solid ingredient additives of any optional additive. The mixing speeds range from 60 to 3000 rpm and temperature of mixing ranges from 250° F. to 430° F. (120° C. to 220° C.), typically 325° F. (163° C.). Then, the melted mixture is put on to a two roll mill at 320° F./345° F. (160-174° C.). The material is milled for about four minutes and then the milled, compounded strip is then cubed for later extrusion or molding into polymeric articles.

Compounds can be formed into powder, cubes, or pellets for further extrusion or molding into polymeric components and parts.

For laboratory testing, the pellets are re-melted and molded into test samples of size and shape dictated by the standardized test. method.

For commercial, conventional wire and cable cross-head dies are used to form the molten mixture into a covering for the wire or cable.

Extrusion or molding techniques are well known to those skilled in the art of thermoplastics polymer engineering. Without undue experimentation but with such references as “Extrusion, The Definitive Processing Guide and Handbook”; “Handbook of Molded Part Shrinkage and Warpage”; “Specialized Molding Techniques”; “Rotational Molding Technology”; and “Handbook of Mold, Tool and Die Repair Welding”, all published by Plastics Design Library (www.elesevier.com), one can make articles of any conceivable shape and appearance using mixtures of the present invention.

### Usefulness of the Invention

Mixtures of the present invention are indicated for use as coverings (e.g., insulation or jacketing) over wire or cable, whether metallic or optical.

Any elongated material suitable for communicating, transferring or other delivering energy of electrical, optical or other nature is a candidate for the core of the wire or cable of the present invention. Non-limiting examples are metals such as copper or aluminum or silver or combinations of them; ceramics such as glass; and optical grade polymers, such as polycarbonate.

Regardless of the material used as the core to transport energy, the PVC melt mixture then serves as the insulation sleeve or the jacketing cover or both for use in risers or plenums in buildings needing electrical power wires or cables or fiber optic communication wires or cables. Preferably, the compound serves as the jacketing of a plenum wire or cable.

Formation of a wire or cable utilizes conventional techniques known to those having ordinary skill in the art, without undue experimentation. Typically, the core or cores of the wire or cable is/are available along one axis and molten thermoplastic compound is delivered to a specific location using a cross head extrusion die along that axis from an angle ranging from 30 degrees to 150 degrees, with a preference for 90 degrees. Most commonly, the wire is moving along that one axis, in order that delivery of the molten thermoplastic compound to that specific location coats the wire or cable or combination of them or plurality of either or both of them, whereupon cooling forms the insulation or jacket concentrically about the wire or cable. The most common equipment employed is a subset of extrusion equipment called cross head extrusion which propels the core or cores past an extruder dispensing molten thermoplastic compound at approximately 90° to the axis of the moving wire or cable core or cores undergoing cross head extrusion. It has been found that mixtures of the present invention can be used as “drop in replacements” for conventional wire and cable covering using conventional draw-down ratios.

As mentioned previously, one embodiment of the invention is a wire or cable specifically configured for use in a riser, the location in a building in which the wire or cable extends vertically from a floor to a wall or the floor to a ceiling or the floor to another floor above or below the original floor. This vertical location requires the wire or cable to satisfy the UL-1666 riser burn test. Briefly, that test requires a test chamber which simulates an eight feet by four feet building wire shaft, with twelve feet of height between the source of ignition and the floor above. A very large propane burner, (about 495,000 BTU/h) is ignited for a period of 30 minutes. Flames must not extend above the 12 foot mark, in order for the cable to pass the test.

Another embodiment of the invention is a wire or cable specifically configured for use in a plenum, the location in a building in which the wire or cable extends horizontally between a ceiling and the floor above. This horizontal location requires the wire or cable to satisfy the UL-910 plenum burn test.

As explained previously, the compound of the invention can be employed as insulation or jacketing of any number of wire or cable structures for transmission of electrical, optical, or other energy. A non-limiting example of a wire or cable of the present invention is a fiber optic cable. Typically, a fiber optic cable comprises multiple fiber optic bundles surrounded by a single layer of polymer compound as a covering. As such, the PVC mixture of the invention can be considered in the market to be a less expensive, reliable substitute for PVDF compound for wire and cable covering.

The amount of polymer compound used in a wire or cable covering is identified by UL according to UL 444 which correlates the thickness of the covering in relation to the diameter of the cable core.

It is also believed that PVC mixtures of the present invention can be used in the formation of flexible industrial curtains which also require excellent flame retardancy and low smoke generation. Non-limiting examples of industrial curtain include warehouse entrance curtains, welding curtains, and freezer curtains (including those at retail food stores where frozen food items are on display in open display conditions.)

Further evidence of the invention is found in the following examples.

### EXAMPLES

Table 2 shows the sources of ingredients for all Examples and all Comparative Examples. Table 3 shows the processing conditions for making all experimental mixtures. Table 4 shows the molding conditions for testing. Table 5 shows the formulations and test results.

TABLE 2

| Ingredient | Brand Name |
|---|---|
| Polyvinyl Chloride | SUSPENSION RESIN 240 |
| | (OxyVinyls) |
| Chlorinated Polyethylene Plasticizer | WEIPREN CPE 2135 (Lianda) |
| Phosphate FR Plasticizer | SANTICIZER 2248 (Valtris) |
| Polyvinylidene Fluoride (PVDF) | DAIGUARD-770 (Daihachi) |
| Brominated DiOctyl Phthalate Plasticizer | DP-45 (Lanxess) |
| Polycaprolactone | CAPA 6500 (Perstorp) |
| Thermoplastic Polyester Elastomer | HYTREL 3078 (DuPont) |
| Thermoplastic Polyester Elastomer | HYTREL 5526 (DuPont) |
| Linear C9 Trimellitate Plasticizer | Synplast L9TM-E (PolyOne) |
| Aluminum Trihydroxide with Silane | HYMOD (Huber) |
| Surface Treatment | |
| Antimony Oxide | (Campine) |
| Intumescent Char Former | NAFTOCHEM CG-581 (Chemson) |
| Smoke suppressant - Basic Zinc Molybdate | Charmax FS-BZMA |
| Complex on Mg(OH)2 | (Polymer Additives Group) |
| Smoke suppressant - Basic Zinc Molybdate/ | Kemgard HPSS-UF (Huber) |
| Magnesium Hydroxide Complex | |
| Smoke suppressant - Molybdate Complex | CHARMAX LSZ8A |
| | (Polymer Additives Group) |
| Stearic Acid | EMERSOL 132 (DeWolf) |
| Oxidized Polyethylene Wax | OPE AC-629A (Honeywell) |
| Calcium/Zinc Stabilizer | Therm-Chek RC 895P (Valtris) |

TABLE 3
Mixing Instructions
#4 Roll Mill/10 L Henschel/Banbury

| | Standard Conditions | |
|---|---|---|
| PVC Resin | Initial | |
| All Other Ingredients except Polycaprolactone | Directly after Resin | |
| Polycaprolactone Pellets | 140° F. | (60° C.) |
| Henschel Drop Temp | <155° F. | (<68° C.) |
| Cooler Drop Temp | 140-150° F. | (60-65° C.) |

Transfer Powder to Banbury
Set jacket at 300-310° F. (149-154° C.) & speed to 100 rpm
Raise ram twice before dropping fused material ~260° F. & 290° F. (~127° C. & 143° C.)
Drop Compoud at 315-335° F. (157-168° C.) (note sucking sound when fused) ~325° F. (~163° C.)
Drop Plenum at 340° F. (171° C.) (note sucking sound when fused)

# 4 Mill Conditions

| | Compound | | |
|---|---|---|---|
| Initial #4 mill roll set up: | | Front | Back |

| | | | | |
|---|---|---|---|---|
| Mill rolls Temps: | 350° F. | (171° C) | 340° F. | (163° C) |
| Roll speed: | 18 | rpm | 22 | rpm |

Roll gap: 75-90 mils (1.9-2.3 mm)
Mill. for 4 minutes
Set gap ~5-10 mils (0.13-0.25 mm) greater than plaque thickness.
Remove mill strip and cut samples for testing.

TABLE 4
Molding Conditions

150 ton Wabash Press

| | |
|---|---|
| Heating Platen Temp - Top (° F.) | 360 (182° C.) |
| Heating Platen Temp - Bottom (° F.) | 360 (182° C.) |

| | | | |
|---|---|---|---|
| Preheat Cycle | 30 | secs. | NA |
| Ramp Cycle | 60 | secs. | 1300 psi (8.9 MPa) |
| Hold Cycle | 120 | secs. | 1300 psi (8.9 MPa) |
| Cooling Cycle | 900 | secs. | 1300 psi (8.9 MPa) |

The objective of the experiments was to identify formulations which satisfied the following two conditions:

Limiting Oxygen Index of greater 50% according to ASTM D2863; and

Plastic Brittleness less than 0° C. according to ASTM D746 as measured in 2° C. increments.

If possible, two other conditions were desired:

Unaged Elongation at Break of greater than 100% according to ASTM D638 (Type IV); and

Dynamic Thermal Stability of at least about 30 min. according to ASTM 2538.

TABLE 5

| | Comp. | Comp. | Comp. | | | | Comp. | Comp. | Comp. | Comp. |
|---|---|---|---|---|---|---|---|---|---|---|
| Experiments | A | B | C | Ex. 1 | Ex. 2 | Ex. 3 | D | E | F | G |
| PVC SUSPENSION RESIN 240 | 100 | 100 | 100 | 100 | 100 | 100 | 100 | 100 | 100 | 100 |
| WEIPREN 2135 | 0 | 0 | 0 | 0 | 0 | 0 | 0 | 0 | 5 | 15 |
| Chlorinated Polyethylene | | | | | | | | | | |
| SANTICIZER 2248 Plasticizer | 10 | 0 | 0 | 0 | 0 | 0 | 0 | 0 | 0 | 0 |
| DAIGUARD-770 PVDF | | 15 | | | | | | | | |
| Brominated DiOctyl | 15 | 10 | 25 | 25 | 25 | 25 | 25 | 25 | 25 | 25 |
| Phthalate Plasticizer | | | | | | | | | | |
| CAPA 6500 | 15 | 15 | 15 | 15 | 10 | 0 | 10 | 0 | 10 | 0 |
| Polycaprolactone Plasticizer | | | | | | | | | | |
| HYTREL 3078 Thermoplastic | 0 | 0 | 0 | 0 | 5 | 15 | 0 | 0 | 0 | 0 |
| Polyester Elastomer | | | | | | | | | | |
| HYTREL 5526 Thermoplastic | 0 | 0 | 0 | 0 | 0 | 0 | 5 | 15 | 0 | 0 |
| Polyester Elastomer | | | | | | | | | | |
| Synplast L9TM-E | 15 | 15 | 15 | 15 | 15 | 15 | 15 | 15 | 15 | 15 |
| Trimellitate Plasticizer | | | | | | | | | | |
| ATH SILANE TR Flame | 70 | 70 | 80 | 80 | 80 | 80 | 80 | 80 | 80 | 80 |
| Retardant | | | | | | | | | | |
| Antimony Trioxide | 2 | 2 | 2 | 2 | 2 | 2 | 2 | 2 | 2 | 2 |
| NAFTOCHEM CG-581 | 5 | 5 | 5 | 5 | 5 | 5 | 5 | 5 | 5 | 5 |
| Char Former | | | | | | | | | | |
| Charmax FS-BZMA Smoke | 20 | 20 | 20 | 0 | 20 | 20 | 20 | 20 | 20 | 20 |
| Suppressant | | | | | | | | | | |
| Kemgard HPSS-UF Smoke | 0 | 0 | 0 | 20 | 0 | 0 | 0 | 0 | 0 | 0 |
| Suppressant | | | | | | | | | | |
| CHARMAX LSZ8A Smoke | 10 | 10 | 0 | 0 | 0 | 0 | 0 | 0 | 0 | 0 |
| Suppressant | | | | | | | | | | |
| Stearic Acid | 0.1 | 0.1 | 0.1 | 0.1 | 0.1 | 0.1 | 0.1 | 0.1 | 0.1 | 0.1 |
| OPE AC-629A Oxidized PE | 0.5 | 0.5 | 0.5 | 0.5 | 0.5 | 0.5 | 0.5 | 0.5 | 0.5 | 0.5 |
| Wax | | | | | | | | | | |
| Therm-Chek RC 895P | 7 | 7 | 7 | 7 | 7 | 7 | 7 | 7 | 7 | 7 |
| Ca/Zn Stabilizer | | | | | | | | | | |
| Total | 269.6 | 269.6 | 269.6 | 269.6 | 269.6 | 269.6 | 269.6 | 269.6 | 269.6 | 269.6 |

Testing Results
Unaged Properties

| | | | | | | | | | | |
|---|---|---|---|---|---|---|---|---|---|---|
| Specific Gravity (ASTM D792) | 1.6143 | 1.6334 | 1.6414 | 1.6924 | 1.6476 | 1.6614 | * | * | 1.645 | 1.6572 |
| Hardness “D”, | 47.8 | 48.2 | 53 | 53.4 | 58 | 63.8 | | | 59.2 | 66.8 |
| 15 s (ASTM D2240) | | | | | | | | | | |
| TS @ Break (psi) | 1911 | 1958 | 1915 | 2073 | 2051 | 1947 | | | 2015 | 2574 |
| (ASTM D638) | | | | | | | | | | |
| EL @ Break (%) | 244 | 238 | 221 | 236 | 207 | 68 | | | 212 | 8 |
| (ASTM D638 (Type IV)) | | | | | | | | | | |

Aged Properties after 10 days @ 100° C.

| | | | | | | | | |
|---|---|---|---|---|---|---|---|---|
| TS @ Break (psi) | 1715 | 1765 | 1691 | 1840 | 1815 | 2312 | 1796 | 2854 |
| (ASTM D638) | | | | | | | | |
| Retention of TS (%) | 90 | 90 | 88 | 89 | 88 | 119 | 89 | 111 |
| (ASTM D638) | | | | | | | | |
| EL @ Break (%) | 241 | 211 | 198 | 213 | 162 | 14 | 197 | 0.75 |
| (ASTM D638 (Type IV)) | | | | | | | | |
| Retention of EL (%) | 99 | 89 | 90 | 90 | 78 | 21 | 93 | 9 |
| (ASTM D638) | | | | | | | | |

Aged Properties after 7 days @ 121° C.

| | | | | | | | | |
|---|---|---|---|---|---|---|---|---|
| TS @ Break (psi) | 1868 | 1947 | 1861 | 1988 | 1999 | 2062 | 1904 | 3090 |
| (ASTM D638) | | | | | | | | |
| Retention of TS (%) | 98 | 99 | 97 | 96 | 97 | 106 | 94 | 120 |
| (ASTM D638) | | | | | | | | |
| EL @ Break (%) | 196 | 192 | 202 | 234 | 183 | 21 | 191 | 10 |
| (ASTM D638 (Type IV)) | | | | | | | | |
| Retention of EL (%) | 80 | 81 | 91 | 99 | 88 | 31 | 90 | 125 |
| (ASTM D638) | | | | | | | | |

Unaged Properties

| | | | | | | | | |
|---|---|---|---|---|---|---|---|---|
| Brittleness (deg C.) | −11 | −10 | −4 | −7 | −2 | 2 | 1 | 10 |
| (ASTM D746 as measured | | | | | | | | |
| in 2° C. increments) | | | | | | | | |
| LOI (%) (ASTM D2863) | 46.6 | 47.6 | 51.3 | 52.3 | 51.3 | 51.8 | 53.6 | 54.8 |
| Dynamic Thermal Stability | 98 | 26 | 89 | 97 | 101 | 85 | 83 | 49 |
| (Minutes) (ASTM 2538) | | | | | | | | |
| ASTM E662 Flaming Mode; | 209.25 | 142.88 | 206.55 | 220.39 | 199.21 | 178.08 | 240.26 | 219.95 |
| Ds Max corrected | | | | | | | | |

* Unable to be formed into testing plaques.

Based on the four conditions listed above Table 5, the formulations of Examples 1-3 achieved the goal. Comparative Examples A and B lacked LOI of greater than 50%. Comparative Examples C-G lacked Brittleness of less than 0° C. Only Examples 1-3 achieved both conditions.

One difference between the Comparative Examples A-G and Examples 1-3 was the amount of molybdate-based smoke suppressant at between 20 and 30 PHR. Depending on progress in the field of molybdate-based smoke suppressants, it is contemplated that as little as 10 PHR can be used in the future. Also, depending on cost considerations, as much as 50 PHR can be used successfully.

Another distinguishing ingredient was the presence of at least 10 PHR of polycaprolactone plasticizer.

Another distinguishing ingredient was the presence of at least 30 PHR of aluminum trihydrate.

Another distinguishing ingredient was the presence of at least 25 PHR brominated dioctyl phthalate plasticizer.

A distinguishing characteristic of Examples 1-3 is the absence of PVDF from mixtures of the present invention having the goal of replacing PVDF thermoplastic mixtures.

Another distinguishing characteristic of Examples 1-3 was the absence of phosphate flame retardant plasticizer, even though three other plasticizers are indicated in various amounts.

Another distinguishing characteristic of Examples 1-3 was the absence of chlorinated polyethylene plasticizer, even though three other plasticizers are indicated in various amounts.

Though the differences between Comparative Examples A-G and Examples 1-3 were incapable of prediction before experimentation, among the many possible combinations of ingredients, now that the particular combination of ingredients are identified in the inventive mixtures, a person having ordinary skill in the art without undue experimentation can vary the amounts of the ingredients within the acceptable ranges and consider other additives identified above as supplementary properties for wire and cable covering end uses.

The invention is not limited to the above embodiments. The claims follow.

1. A mixture comprising:
poly(vinyl chloride);
brominated dioctyl phthalate plasticizing the poly(vinyl chloride);
polycaprolactone plasticizing the poly(vinyl chloride);
linear C₉ trimellitate plasticizing the polyvinyl chloride);
silane surface treated aluminum trihydrate flame retardant;
antimony trioxide flame retardant;
intumescent char former;
molybdate-based smoke suppressant;
stearic acid;
oxidized polyethylene wax; and
calcium/zinc stabilizer;
wherein the mixture has both a Limiting Oxygen Index of greater than 50% according to ASTM D2863 and a Plastic Brittleness of less than 0° C. according to ASTM D746 as measured in 2° C. increments.

2. The mixture of claim 1, wherein the mixture has:
an unaged Elongation at Break of greater than 100% according to ASTM D638 (Type IV); and
a Dynamic Thermal Stability of at least about 90 min according to ASTM 2538.

3. The mixture of claim 1, wherein the mixture has:
100 of polyvinyl chloride);
10-50 PHR of brominated dioctyl phthalate plasticizing the poly(vinyl chloride);
10-20 PHR of polycaprolactone plasticizing the poly(vinyl chloride);
12-18 PHR of linear C₉ trimellitate plasticizing the poly(vinyl chloride);
75-85 PHR of silane surface treated aluminum trihydrate flame retardant;
1-5 PHR of antimony trioxide flame retardant;
3-7 PHR of intumescent char former;
20-29 PHR of molybdate-based smoke suppressant;
0.05-1 PHR of stearic acid;
0.1-1 PHR of oxidized polyethylene wax; and
3-9 PHR of calcium/zinc stabilizer.

4. The mixture of claim 1, wherein the mixture has:
100 PHR of poly(vinyl chloride);
15-40 PHR of brominated dioctyl phthalate plasticizing the poly(vinyl chloride);
12-18 PHR of polycaprolactone plasticizing the poly(vinyl chloride);
13-17 PHR of linear C₉ trimellitate plasticizing the poly(vinyl chloride);
78-82 PHR of silane surface treated aluminum trihydrate flame retardant;
2-3 PHR of antimony trioxide flame retardant;
4-6 PHR of intumescent char former;
20-27 PHR of molybdate-based smoke suppressant;
0.04-0.5 PHR of stearic acid;
0.3-0.7 MR of oxidized polyethylene wax; and
5-8 PHR of calcium/zinc stabilizer.

5. A wire or cable covering, comprising the mixture of claim 1.

6. A wire or cable covering, comprising the mixture of claim 2.

7. A wire or cable covering, comprising the mixture of claim 3.

8. A wire or cable covering, comprising the mixture of claim 4.

9. A wire or cable comprising the wire or cable covering of claim 5.

10. The wire or cable of claim 9, wherein the wire or cable is a plenum wire or cable.

11. The wire r cable of claim 9, wherein the wire or cable is a riser wire or cable.

12. The wire or cable of claim 9, wherein the covering is a wire or cable insulation or jacketing.

13. The wire or cable of claim 9, wherein the wire or cable has a transmission core of optical fiber.

14. The wire or cable of claim 9, wherein the wire or cable has a transmission core of metal wire.

15. A method of using plasticized poly(vinyl chloride) in wire or cable covering, comprising:
mixing the mixture of claim 1 to form a plasticized polyvinyl chloride;
extruding the plasticized polyvinyl chloride around a transmission core of optical fiber or metal wire to form a plenum wire or cable.

16. An industrial curtain, comprising the mixture of claim 1.

17. The mixture of claim 2, wherein the mixture has:
100 PHR of poly(vinyl chloride);
10-50 PHR of brominated dioctyl phthalate plasticizing the poly(vinyl chloride);
10-20 PHR of polycaprolactone plasticizing the polyvinyl chloride);
12-18 PHR of linear C₉ trimellitate plasticizing the poly(vinyl chloride);
75-85 PHR of silane surface treated aluminum trihydrate flame retardant;
1-5 PHR of antimony trioxide flame retardant;
3-7 PHR of intumescent char former;
20-29 PHR of molybdate-based smoke suppressant;
0.05-1 PHR of stearic acid;
0.1-1 PHR of oxidized polyethylene wax; and
3-9 PHR of calcium/zinc stabilizer.

18. A wire or cable covering, comprising the mixture of claim 17.

19. The mixture of claim 2, wherein the mixture has:
100 PHR of poly(vinyl chloride);
15-40 PHR of brominated dioctyl phthalate plasticizing the poly(vinyl chloride);
12-18 PHR of polycaprolactone plasticizing the poly(vinyl chloride);
13-17 PHR of linear C₉ trimellitate plasticizing the poly(vinyl chloride);
78-82 PHR of silane surface treated aluminum trihydrate flame retardant;
2-3 PHR of antimony trioxide flame retardant;
4-6 PHR of intumescent char former;
20-27 PHR of molybdate-based smoke suppressant;
0.04-0.5 PHR of stearic acid;
0.3-0.7 of oxidized polyethylene wax; and
5-8 PHR of calcium/zinc stabilizer.

20. A wire or cable covering, comprising the mixture of claim 19.
